(19) United States
(12) Patent Application Publication
(10) Pub. No.: US 2002/0163817 A1
(43) Pub. Date: Nov. 7, 2002

(54) Method and apparatus for a bicycle lighting system

(76) Inventor: Clifton R. Bukowsky, Vienna, VA (US)

Correspondence Address: HUGHES & LUCE LLP, ATTORNEYS AND COUNSELORS, Suite 2800, 1717 Main Street, Dallas, TX, 75201, US

(21) Appl. No.: 09/851,032

(22) Filed: May 7, 2001

(51) Int. Cl. B60Q 1/00

(52) U.S. Cl. 362/500; 362/473; 362/276; 362/286

(57) ABSTRACT

A bicycle lighting system has a lighting mechanism attached to a wheel of the bicycle. As the wheel revolves, an actuator activates the light at a predetermined point. The actuation may be physical or electromagnetic in nature. The actuation triggers the lighting of light contained in the lighting mechanism. The light beams may emanate parallel to the path defined by the spokes, or perpendicular to the emanating spokes. To an observer from the front, the light travels downward over the effective wheel height, transforming the light into an elongated light source equal to the wheel height. The rate at which the light source travels downward gives rotational information. The lighting may be for a predetermined time. Or, either of the lights may be strobed. A timing circuitry sensitive to rotational information allows the lights to be switched on and off at predetermined times and/or points in the revolution of the wheel. Delays may be introduced, and strobing effects may be also introduced. In an exemplary aspect, the strobe rate may set at a rate proportional to the revolution rate.

### BACKGROUND OF THE INVENTION

1. Field Of The Invention

The present invention generally relates to a method and apparatus for implementing lights on a wheeled vehicle. In particular, the invention relates to a method and apparatus by which lights contained on the wheel of a bicycle are adaptively lit in response to the speed of the bicycle and provide a wide illumination range.

2. Description of Prior Art

Typical bicycle lights are contained on the frame of bicycle. This configuration of bicycle and light allows the light to fall light either directly in front of or directly in back of the bicycle in a constant matter. However, the constancy of the light source provides for many deficiencies. In short, the typical lighting systems do not indicate the rate at which a bicycle is traveling, they give no indication to persons except to those in front of and possibly in back of the bicycle, and the beam delimits an especially small light source.

First, these typical lighting solutions suffer from deficiencies in the fact that the lights are not visible to the side of the traveling bicycle. The typical head lamp shines to the front only. In this manner, only persons or vehicles to the front of the bicycle can observe the oncoming light source attached to the bicycle.

If a rear lamp is provided for, the beam arc is only visible to the rear of the bicycle. Thus, observers from the side views or diagonal views relative to the facing of the bicycle may not see the bicycle as it moves.

Second, many of these typical lighting solutions do not give an indication to an oncoming car or motor vehicle as to the relative velocity of the bicycle. A vehicle that is oncoming or approaching from the rear of the bicycle only sees a point light source. The light source grows as the distance between the vehicle and the bicycle decreases. There is no indication to such a vehicle as to the velocity of the bicycle, or of the rotational aspects of the bicycle's tires that could indicate such a velocity.

Another limitation to many typical bicycle lighting systems is in that the outgoing light is contained to a relatively small point. To oncoming traffic, the light source only appears as either an increasing or decreasing size point light source. In this manner, an oncoming vehicle may not be able to fully appreciate the position and/or velocity of the oncoming bicyclist due to the limited light producing area, and because of no information of the relative speed or velocity.

Additionally, these typical lighting systems do not provide any indication of the same bicycle motion information to a vehicle approaching from the sides. This is because there is no active lighting to the sides of the bicycle.

Some bicycles attempt to make up for this limitation with reflectors on the frame or on the wheel spokes. However, this solution fails, since they provide no active warning since they reflect only light that falls upon them. The reflectors rely on another external lighting source, and as such do not actively indicate the presence of the bicycle to its surroundings.

In this manner, the typical warning lights and reflectors suffer one or more shortcomings. Many other problems and disadvantages of the prior art will become apparent to one skilled in the art after comparing such prior art with the present invention as described herein.

### SUMMARY OF THE INVENTION

Aspects of the invention are found in a bicycle lighting system. The bicycle lighting system has a lighting mechanism attached to a wheel of the bicycle or other wheeled vehicle. An actuator activates the lighting mechanism when the light reaches a predetermined point as the wheel revolves when the bicycle is moving. The actuation may be physical or electromagnetic in nature.

The actuation triggers the lighting of light contained in the lighting mechanism. The light beams may emanate along and parallel to the path defined by the spokes of the wheel, or substantially perpendicular to the plane of the wheel as defined by the emanating spokes. The actuation device may actuate these lights singly or in combination. The lights may be triggered immediately, in a delayed manner, or in a series of switching on and off, such as a strobe like effect.

As to the lights directed along the direction of the spokes, the light effectively defines a virtual light. The use of a single or multiple light sources can be employed with a strobing effect for greater visibility. Used in conjunction with the movement of the wheel, this creates a virtual light that illuminates a larger area than a single fixed light device.

The movement, optionally employed with the strobing, allows for a much larger display of light from a limited light source. This tends to create a virtual light strip on the wheel creating a larger visible lighted area of the vehicle.

On the front wheel, the light makes a traversal from the top of the wheel radius to the bottom as the light source revolves with the wheel. This effectively makes an elongated light source extending from the top of the wheel base to the bottom. To an observer from the front, the light makes a downward motion over most of the effective wheel height, transforming a single point light source into a light source equal to the height of the wheel base. Additionally, the rate at which the light source is visible to the observer gives rotational information about the wheel to the observer, and intuitively gives information about the vehicle's velocity.

On the rear tire, the effect would be opposite, as the light would traverse from bottom to top as the vehicle moves forward. To an observer form the back, this would create a visual effect of a strip of moving light or lights moving from bottom to top along the effective height of the rear wheel.

As stated above, the lighting may be for a single set period of time. Or, either of the lights may be strobed on and off.

The lights may be timed by a timing circuitry sensitive to rotational information. In this manner, the light emanating in the direction of the wheel spokes may be switched on and off at predetermined times and or points in the revolution of the wheel. Delays may be introduced, and strobing effects may be also introduced. In an exemplary aspect, the strobe rate may set at a rate proportional to the revolution rate.

In this manner, heightened awareness of the bicycle may be achieved. Additionally, velocity information may be indicated to an observer. Further, the lighting effects may be used to produce vivid and fanciful effects to observers located away from the bicycle.

It should be noted, that while the embodiment describes a lighting system for a bicycle, it is readily adaptable to other types of wheeled vehicles. As such, the application should be construed as covering those other wheeled vehicles as well. Other aspects, advantages, and novel features of the present invention will become apparent from the detailed description of the invention when considered in conjunction with the accompanying drawings.

### BRIEF DESCRIPTION OF THE DRAWINGS

FIG. 1 depicts a bicycle lighting system according to the invention.

FIG. 2 is a top cutaway view of the interaction between the frame assembly, light actuator, and lighting mechanism of FIG. 1.

FIG. 3 is an enlarged view of the lighting mechanism of FIG. 2 demonstrating the orientation and interaction of the lights.

FIGS. 4a-e are a series of figures showing a side view of the bicycle of FIG. 1, illustrating a use of the invention of FIG. 1.

FIGS. 5a through 5e are front views of the diagrams 4a through 4e, respectively.

FIG. 6 is a side view of an embodiment of the lighting mechanism of FIG. 1.

FIG. 7 is a sectional view of the lighting mechanism and its relationship with the actuation mechanism of FIG. 1.

FIG. 8 is a schematic diagram of a possible circuit implementation of the control circuitry of FIG. 7.

FIG. 9 is a schematic diagram of another possible implementation of a control circuitry for the lighting system of FIG. 1.

FIG. 10 is a method that may be employed in the invention as described in relation to FIG. 8.

FIG. 11 is a block diagram detailing a possible operation of the timer of FIG. 10.

### DETAILED DESCRIPTION

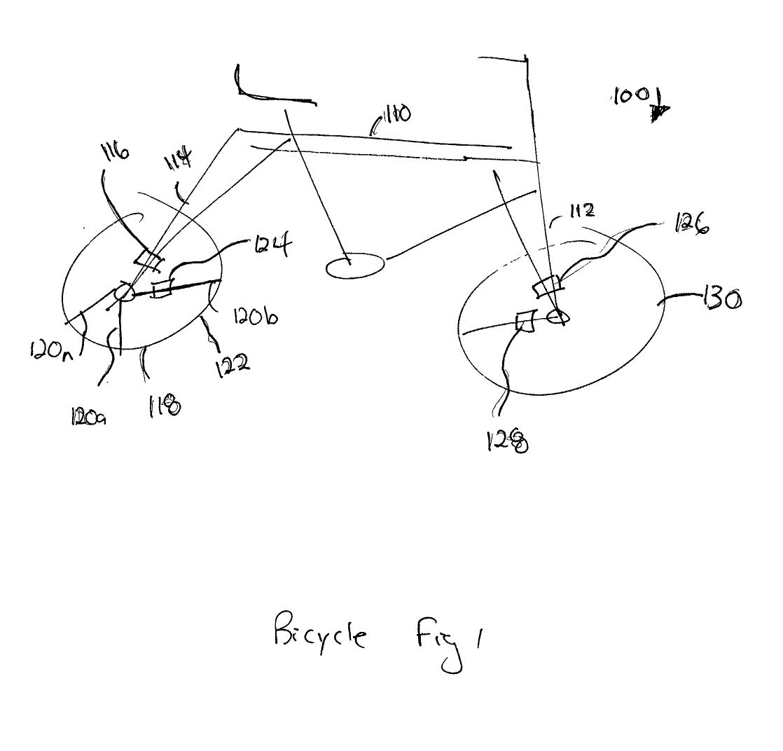

FIG. 1 depicts a bicycle lighting system of the invention. A bicycle 100 contains a frame 110. The frame 110 contains a front wheel fork 112 and a rear wheel fork 114. A light actuator 116 attaches to the bicycle 100 by the frame 110. In an exemplary embodiment, the actuator 116 attaches to the rear wheel fork 114.

A rear wheel 118 attaches to the bicycle frame 110, and is contained within the prongs of the rear wheel fork 114. The rear wheel 118 contains multiple spokes 120 a-n. The spokes emanate from the hub of the bicycle wheel 118 and extend radially from the hub of the bicycle wheel 118 to the edge of a rim 122 on the rear wheel 118.

A lighting mechanism 124 attaches to one or more of the spokes 120 a-n. The lighting mechanism 124 is placed at a distance from the hub of the rear wheel 118, such that the lighting mechanism 124 passes in close proximity to the lighting actuator 116 when the rear wheel 118 revolves, as when the bicycle 100 is in motion.

When the lighting mechanism 124 passes within a certain proximity of the lighting actuator 116, the lighting actuator 116 initiates a lighting of the light contained in the lighting mechanism 124 for a predetermined amount of time.

In one embodiment, the light is initiated for a single predetermined block of time. However, the light may be illuminated in multiple lightings, such as a strobe-like manner.

No matter the type of illumination by the light, the passage of the lighting mechanism by the proximity actuator 116 initiates the illumination of the light. Thus, when the bicycle 100 is in motion, the wheel revolves as the bicycle travels down its path. When the revolving wheel reaches a certain point, passing activates the attached lighting mechanism by the light actuator 116. While the light actuator is defined in terms of a proximity actuator, such as a magnetic type actuator, the actuator may also be a physical actuator. Such physical actuators include a contact switch that actuates the light mechanism when contact is made at a certain point in the rotational cycle.

It should be noted that on the front wheel fork 112, another lighting actuator 126 is placed on the front wheel fork 112. Additionally, another lighting mechanism 128 is placed on the front wheel 130. In a manner substantially similar to the operation of the lighting actuator and the lighting mechanism that is described for the rear wheel 118, the motion of the lighting mechanism 128 past the lighting actuator 126 turns on the light associated with the lighting mechanism 128.

In this manner, a light may be initiated based upon the motion of the wheel. Further, the light may be initiated for a set amount of time, at a set point in the rotational cycle, and/or for a predetermined number of lighting cycles. As such, the turning on and off of the lighting mechanism may indicate a relative indication of the wheel motion. This serves to aid in the identification of the bicycles relative motion from a distance.

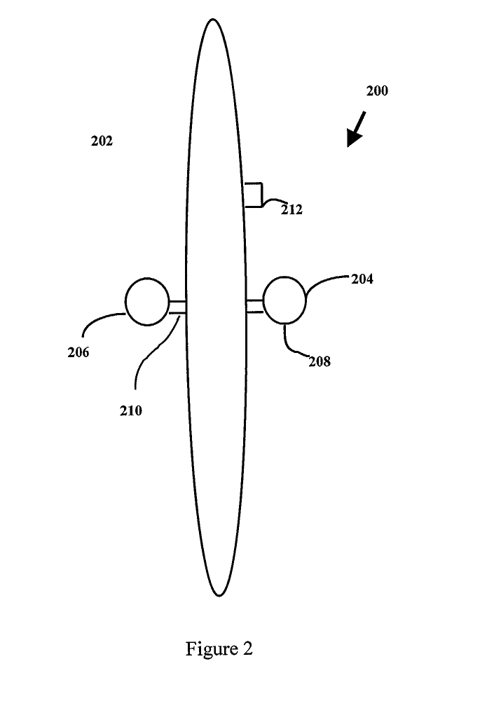

FIG. 2 is a top cutaway view of the interaction between the frame assembly, light actuator, and lighting mechanism of FIG. 1. A bicycle wheel assembly 200 contains a bicycle wheel 202. The bicycle wheel assembly revolves within the frame supports 204 and 206 that make up a wheel fork of a bicycle.

In one embodiment, shown here, a light actuator 208 is attached to a portion of the frame support 204 that makes up the wheel fork of the bicycle. The wheel 202 is attached to the wheel fork of the bicycle via an axle 210.

A lighting mechanism 212 is attached to the wheel assembly 200. The lighting mechanism may be attached in a number of different of places or methods. For example, the lighting mechanism 212 may be attached to the wheel assembly 200 as close to or as far way from the center of rotation as needed or wanted. In one example, the lighting mechanism may be attached to the rim of the wheel assembly 200, or may be attached to the wheel assembly 200 on the spokes that radiate from the axle.

As the wheel assembly rotates, the lighting mechanism 212 passes in proximity to the light actuator 208. After passing in proximity to the light actuator 208, the light 212 is enabled.

Or, the actuator may be attached to the lighting mechanism 212 instead of the frame of the bicycle. In this case, a physical switch may protrude from the lighting mechanism 212. When the physical switch engages or comes into contact with the frame of the bicycle, the engagement of the switch enables the lighting mechanism 212. In another example, the physical switch mechanism may protrude from the bicycle frame. When the lighting mechanism contacts the protruding switch, the light is enabled.

In any case, the revolution of the wheel initiates the lighting of the light mechanism at a predetermined point. It should be noted that the engagement itself might not immediately result in lighting of the light mechanism, only initiate the lighting thereof. This is accomplished through delay circuitry in the lighting mechanism.

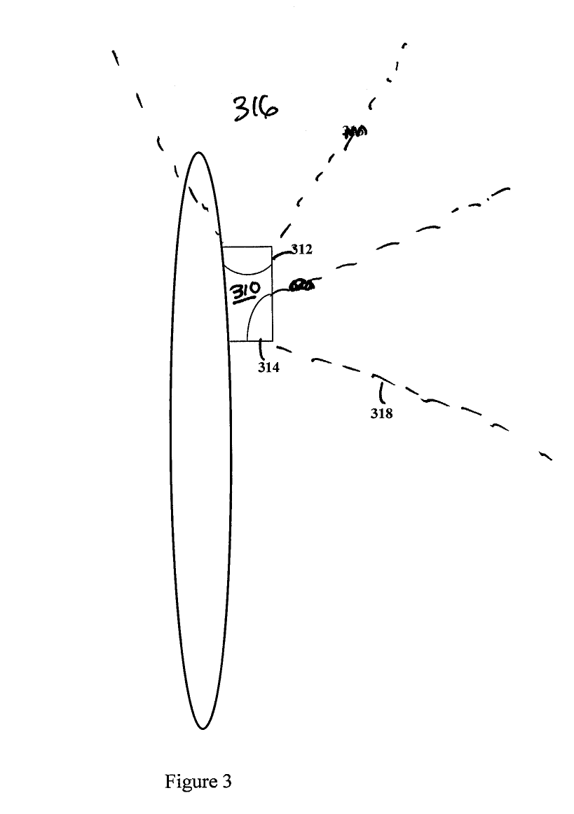

FIG. 3 is an enlarged view of the lighting mechanism of FIG. 2 demonstrating an exemplary orientation of the lights. In this case, the actuation of the lighting mechanism 310 can result in an actuation of a light 312 or of a light 314.

When the light 312 is enabled, a beam of light is directed outward along beam path corresponding to the spokes of the wheel. The dashed cone 316 in FIG. 3 indicates this beam path. Alternatively, a light with an orientation perpendicular to the motion of travel and perpendicular to the plane defined by the radial spokes of the wheel may be initiated as well. In this case, the light 314 is enabled, thus beaming a cone of light perpendicular to the direction of travel and to the spokes of the wheel. The cone of light 318 in the diagram indicates this beam path.

It may be noted that the lighting mechanism according to the invention may contain lighting in either orientation, or both orientations. Thus, the actuator may initiate a light stream in the direction of travel, or in a direction perpendicular to the spokes of the wheel.

Other combinations of actuation and lighting may also take place within the scope of the innovation. For example, the light 314 may remain on at all times, while the actuation initiates the lighting of the light source 312. Or, conversely, light source 312 may remain lighted constantly while the passage of the lighting mechanism 310 past the actuation mechanism may initiate the lighting of the light 314. Or, the passage of the lighting mechanism 310 about the actuation mechanism may initiate the lighting of both the lights 312 and 314.

As noted before, each lighting circuit may contain different lights, lighting colors, and/or timing considerations. Different delays associated with each light may result in the turning on and off of the lights at different times and in different sequences as they pass the actuation mechanism. Or, in place of a solid lighting system, the system may use various forms of solid lights and strobe lamps. The use of strobes may greatly enhance the visibility of the light at a distance and improve the ability of a nearby onlooker to perceive such a lighting system.

This is especially true with a strobe light sequence on the light 314 perpendicular to the wheel 318. With the combination of a set strobe frequency and variation of wheel speeds, this could be designed to create lighting effects that make the wheel appear to rotate in one direction, and as the speed of the wheel increases or decreases, the wheel would thus appear to change directions. This would create additional attention and awareness of the vehicle.

With an appropriate delay for the light emanating in the direction of travel, the lighting system can be viewed from an oncoming position as a single light moving from the top to the bottom of the full wheelbase. This corresponds to the light revolving on the wheel and changing its facing as the wheel revolves. This may dramatically increase the effectiveness of a lighting system in view of oncoming traffic. The effect is akin to having a light source made from the entire wheelbase, rather than from a single point source.

In this example, the light may either delay until a certain point in the rotation cycle of the wheel, or the light may turn on immediately following actuation. As light goes through the revolution of the wheel, the light would increasingly be turned toward a direction in the line of travel. As such, to an observer directly in front of the approaching bicycle, a point of light would appear at the top of the arc cut by the light in its rotation around the hub. As the bicycle makes progress towards the frontal observer, the direction of the light changes from a direction of pointing straight up to that of pointing directly at the observer from the frontal position. Then, the light would slowly point to a completely down position, wherein the light would be shining directly from its prescribed place on the wheel radius into the ground.

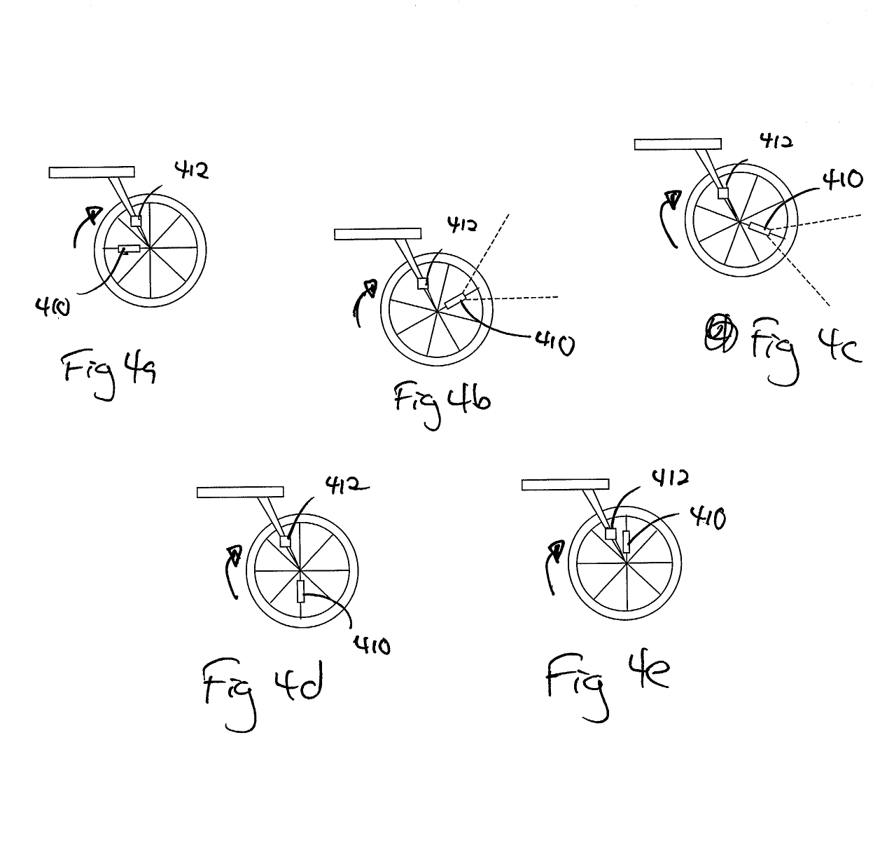

FIGS. 4a-e are a series of figures showing a side view of the front wheel of the bicycle illustrating a use of the invention of FIG. 1. In FIG. 4a, the lighting mechanism 410 has yet to reach the light actuating mechanism 412. In FIG. 4b the lighting mechanism 410 has passed through the lighting actuator 412 and has initiated the shining of a light 414. As shown in the diagram the light is sent out along a radial path from the lighting mechanism 410. At this point in the cycle, the majority of the light is directed upward, but a portion is still traveling in a horizontal manner. As such, an observer may see the rotating light to the front of the bicycle prior to the direction of the light source being horizontal to the plane of the observer.

FIG. 4c shows the continuation of the lighting mechanism 410 as the wheel continues to travel forward. In this manner, the lighting mechanism has broadcast its light continuously or in a strobe fashion throughout the travel from its position relative to that in FIG. 4b. FIG. 4d shows the lighting mechanism 410 wherein the lighting mechanism has ceased to operate after a set delay. In this manner, the use of the lighting mechanism on the wheel creates a virtual light that is larger and more distinctive than previous fixed lights on a bicycle.

FIG. 4e is one alternative to the mechanism as described relative to FIGS. 4a through 4e above. FIG. 4e should be construed as a FIGURE occurring between the times of FIG. 4a and 4b, diagramed above. In this case, the lighting mechanism 410 has passed through the actuation point 412. However, the lighting mechanism 410 has not initiated the light beam. This may be beneficial since the light beam may be toggled on a pre-set time or dynamically alterable time after the actual actuation to avoid the light from flooding the bicycle operator's vision. This is particularly useful at night, so as not to impair the night-sightedness of the operator of the bicycle. However, it should be noted that in some embodiments, an immediate actuation might take place.

It should also be noted that the actual actuation of the lighting mechanism might take place by several means. In one embodiment, a magnetic reed switch contained within the lighting mechanism, such as a magnetic actuator, actuates the lighting mechanism. When the reed switch contained within the lighting mechanism passes through or passes in close proximity to the magnetic actuator contained on the frame of the bicycle, the magnetic field propagated by the magnetic actuator will close the reed switch. This allows a current to flow to the lighting mechanism.

Or, as noted above, other actuation schemes may be used in lieu of a magnetic actuation. Other embodiments of an actuating device may be a physical actuation through a thin switch, or by a reflective or optical actuation mechanism contained therein. In the case of an optical actuation, the lighting mechanism may emit a small beam of light in a direction towards the actuation device. The actuation device may be a simple reflective material. When the beam passes by the reflective material actuation device, a portion of light is reflected back to the light mechanism. This reflected light may then be detected optically and serves to initiate the actuation of the lighting mechanism.

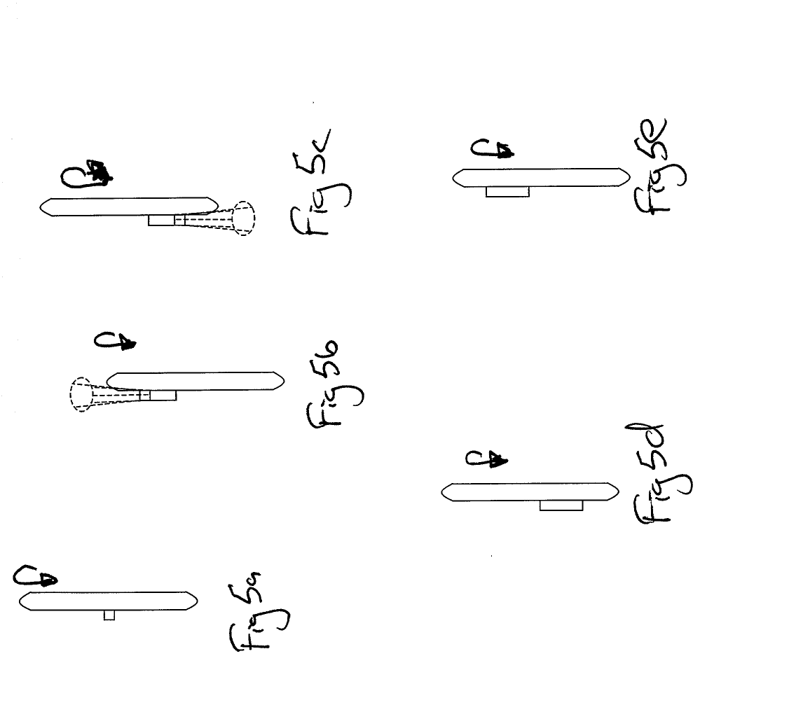

FIGS. 5a-e are front views of the diagrams 4a through 4e, respectively. These orientations more fully describe the exemplary embodiments of the invention.

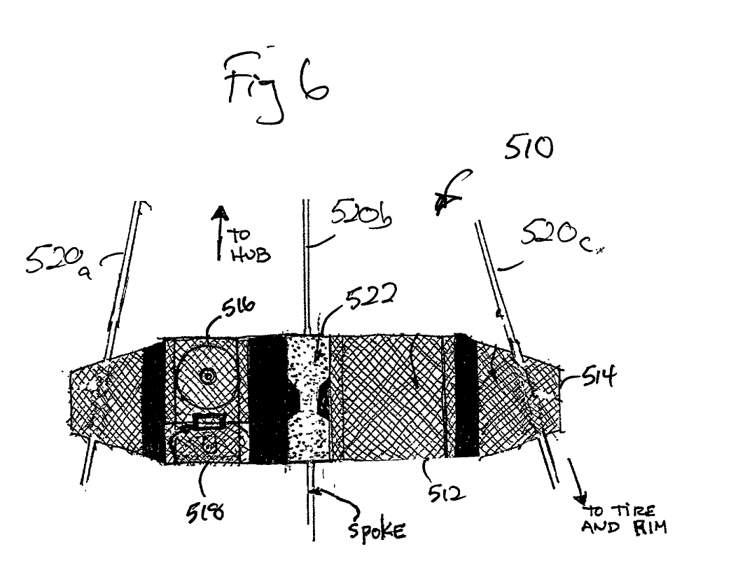

FIG. 6 is a side view of an embodiment of the lighting mechanism of FIG. 1. The lighting mechanism 510 may contain reflectors 512 and 514. Additionally, the lighting mechanism 510 may contain a side light 516. The side light may be a light-emitting diode (LED), or may be a low power reflective strobe. Additionally, the lighting mechanism 510 may contain a downward and/or outward-facing lighting mechanism 518.

The lighting mechanism may be attached to the wheel of the bicycle by several different methods and in several different orientations. In the pictured embodiment, the lighting mechanism is attached to the spokes of the wheel, 520a-c.

In the exemplary embodiment shown in FIG. 6, the lighting mechanism and associated sensor are shown attached to a single spoke 520b through a locking device 522. It should be noted that the lighting mechanism may be attached to multiple spokes, or may be attached to the rim of the wheel itself.

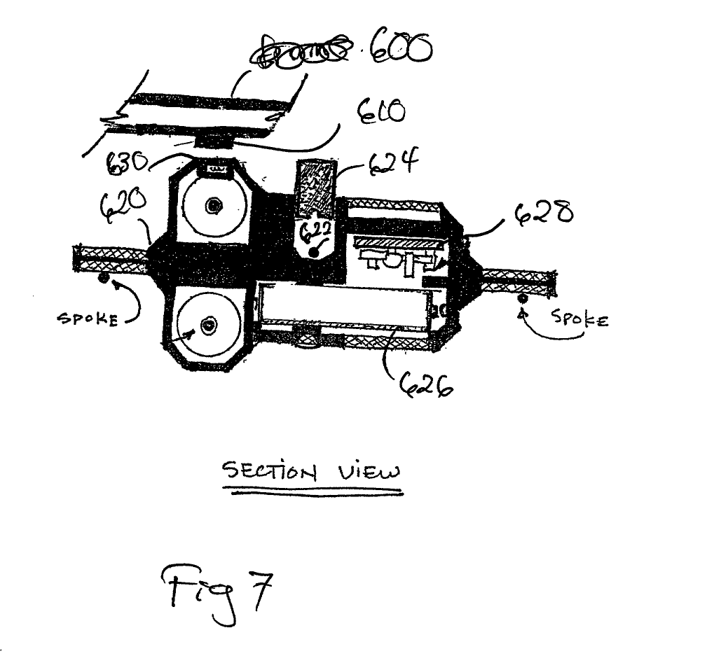

FIG. 7 is a sectional view of a lighting mechanism and its relationship with the actuation mechanism of FIG. 1. In this case, the frame 600 has an attached actuation device 610. A lighting mechanism 620 is attached to the wheel of the bicycle. In this case, the lighting mechanism 620 is attached to a spoke 622 through a locking device 624. In this embodiment, the locking device may be made of rubber, but the locking device of numerous designs, depending upon the individual design parameters or criteria.

The lighting mechanism 620 has a power source 626 and control circuitry 628. The lighting mechanism 620 has an actuation sensor 630. Upon the passage of the wheel by the actuator 610, the actuation sensor 630 detects such passage. This event is relayed to the control circuitry 628. The control circuitry 628 then powers the side and/or downward and outward lights in a pre-determined or dynamically programmed fashion.

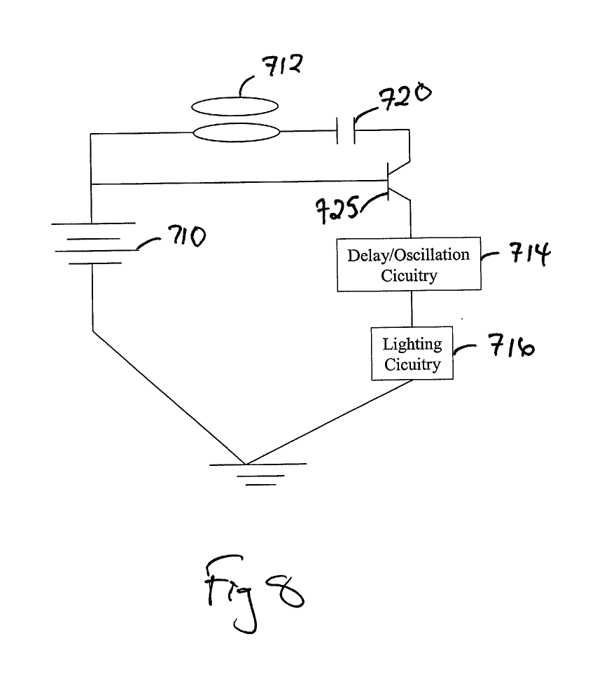

FIG. 8 is a schematic diagram of a possible circuit implementation of the control circuitry of FIG. 7. A power source 710 is coupled to an actuation switch 712. The actuation switch 712 implements the operation of a delay or oscillator circuitry 714. Upon the passage of the actuating device through the actuating sensor, a delay oscillator control circuitry 714 controls the operation of a lighting element 716.

In this case, all the circuitry may be formed using simple circuit elements and implemented as well in an analogue format. As the sensor passes through the actuator device, the transistor 725 is enabled. This allows the electric current to reach the delay and oscillating circuitry 714, which then powers the lighting mechanism 716. The delay and oscillating circuitry may take many forms causing intermittent lighting and unlighting of the lighting mechanism, as well as predetermined delays.

The reed switch 712 is an effective switch that enables the transistor 725 to transmit a current to the delay/oscillator circuitry 714. The use of the capacitor 720 in the figure depicted allows for the apparatus to cease working when the reed switch is continuously in a closed position. As the capacitor becomes charged, the flow of current ceases to the base of the transistor 725. When the flow out of the capacitor 720 ceases, the transistor switch is off, thus inhibiting the operation of the lighting system.

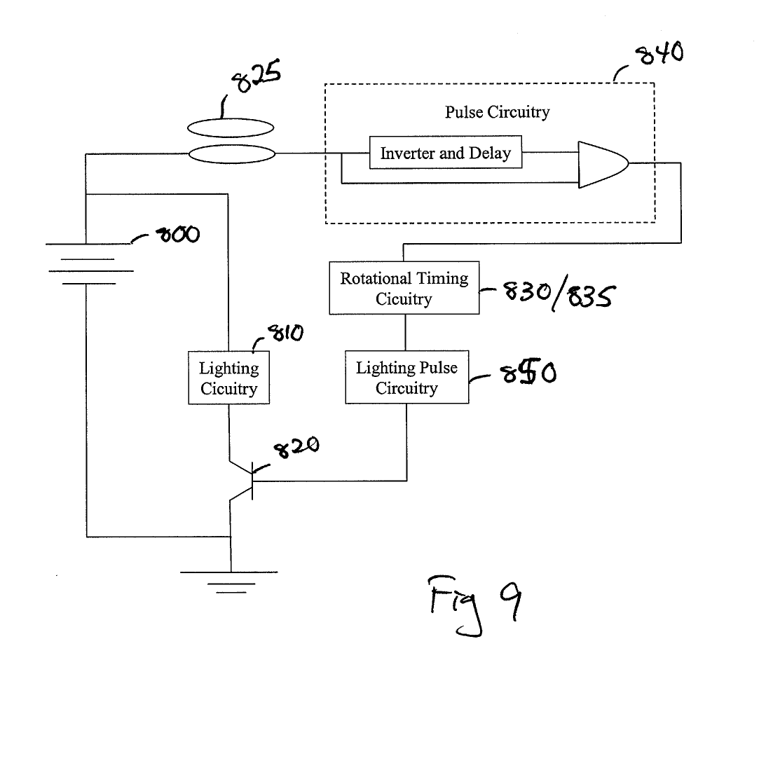

FIG. 9 is a schematic diagram of another possible implementation of a control circuitry for the lighting system of FIG. 1. In this case, the timing and strobing of the light are implemented and controlled in a digital domain. A power source 800 is connected to a lighting mechanism 810. However, the lighting mechanism 810 is terminated at a transistor 820. Thus, when the transistor 820 is switched off, no current will flow through the lighting mechanism 810.

The power source 800 is also connected through an actuation switch 825. When the actuation switch 825 is enabled, the actuation event is transmitted to a pulse manufacturing circuitry 840.

In the present embodiment, the pulse generation circuitry manufactures a clean digital pulse based on the activation of the reed switch 825. This may be implemented in a variety of ways.

An indication of the wheel passing the actuation mechanism 825 is thus communicated to a wheel-timing circuitry 830. The wheel-timing circuitry may also determine the rotational speed of the wheel in revolutions-per-minute.

The rotations-per-minute calculation circuitry then determines a signal pulse or series of signals to enable the light source 810. The manner in which the rotations-per-minute calculating circuitry operates can allows a determination of a delay for the enabling of the light source 810. This allows the lighting of the lighting mechanism 810 when the wheel is in a particular orientation.

Additionally, the rotations-per-minute calculating circuitry can also determine the length of time that the light source 810 is enabled. The rotations-per-minute calculating circuitry may also be used to determine pulsing characteristics as well. The pulsing characteristics can be related to the rotational velocity of the wheel.

The strobe pulses may be of uniform time length, and thus more pulses are generated for a particular arc that the light is enabled. Or, the pulse width can be altered based on the rotational velocity of the wheel.

In either case, the rotations-per-minute calculation circuitry 835 uses the information from the timing circuitry 830 is also used to calculate delay in the lighting of the light source 810. In this manner the light source 810 can be initiated when the outward-facing lights are shining away from the operator of the bicycle, or at any other predetermined point on the rotation cycle. Additionally, the rotations-per-minute calculation can also determine the optimal time to turn off the operation of the light source 810, as well as all pulsing characteristics.

In the exemplary embodiment, the rotations-per-minute calculating circuitry 835 initiates the operation of the light source 810 by enabling a transistor 850 to ground via a pulse generation circuitry 840. In this manner, the circuitries associated with the lighting mechanism can determine an optimal time to switch on the light source of the lighting mechanism, and the operational characteristics thereof. Additionally, a strobe light based upon the rotational characteristics of the wheel may also be implemented in this manner.

In cases where the lighting mechanism has more than one light source, the timing may initiate multiple pulses to the sources. In this manner quite complicated lighting schemes can be employed, such as a “moving strip” of lights running up and down the face of the light mechanism.

It should be noted that the functionality of the circuitry 825, the rotations-per-minute calculation circuitry 830 may be implemented in a number of ways. They may be implemented as a monolithic controller device, or may be implemented in discrete components. Additionally, the switching capabilities of the transistor 850 to ground may be implemented solely as output control signals powering the light, rather than as a switching signal.

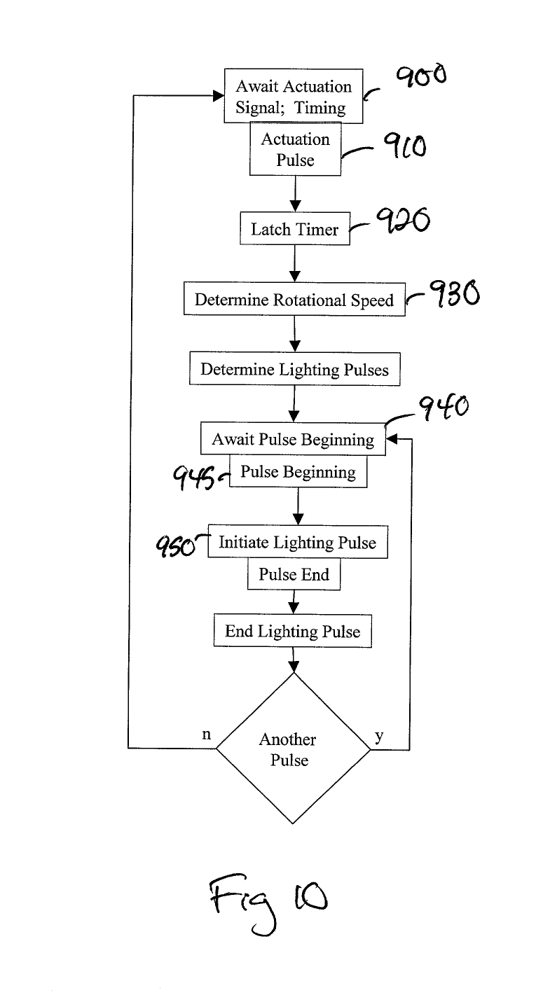

FIG. 10 is a method that may be employed in the invention as described in relation to FIG. 8. In a block 900, the system awaits the passage of the predetermined point on the wheel past the light actuator. In this block, a timer is operating that times the passage of the actuation device. In a block 910, the actuator has passed by the predetermined point, indicating that the lighting mechanism is at some predetermined point. Control passes to the block 920, where the timer is latched and read, indicating the time that the wheel took to complete a revolution.

In a block 930, the time per revolution is determined, allowing the determination of lighting characteristics related to the rotational velocity of the wheel. In a block 940, the system waits a delay time to initiate the lighting of the light, based upon the prescribed starting position of the light and the revolution speed of the wheel. In a block 945, the prescribed time has arrived and the control signal is initiated.

Control passes to a block 950 where the signals or pulses controlling the operation of the light are relayed to actuate the light. In this manner, one or a series of signals are relayed to the lighting mechanism.

When the prescribed pulse or series of pulses controlling the lighting characteristics has occurred, where the system then returns to the block 900 to await another passage of the actuator past the actuation point.

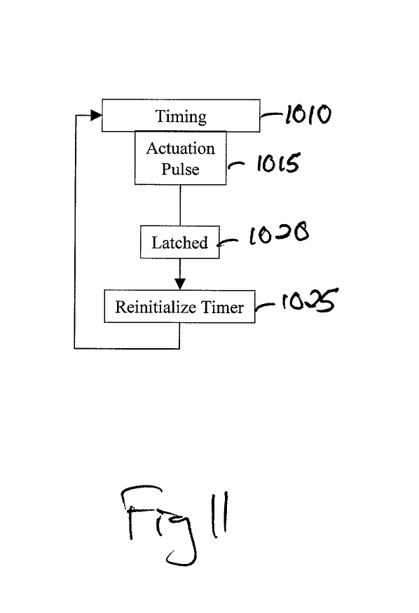

FIG. 11 is a block diagram detailing a possible operation of the timer of FIG. 10. In a block 1010, the timer tracks the passage of time between actuation events. In a block 1015, the actuation event occurs. The value of the revolution timer is latched in a block 1020, and the clock is reinitialized in the block 1025. Control then returns to the block 1010 where the system awaits another actuation event.

As such, a method and apparatus for a bicycle lighting system is described. In view of the above detailed description of the present invention and associated drawings, other modifications and variations will now become apparent to those skilled in the art. It should also be apparent that such other modifications and variations may be effected without departing from the spirit and scope of the present invention as set forth in the claims which follow.

What is claimed is:

1. An lighting apparatus for a vehicle, the vehicle having a wheel and a frame, the apparatus comprising:
a light that shines in a first direction when enabled;
an actuator, communicatively coupled to the light, that transmits a signal for controlling the operation of the light; and
the actuator transmitting the signal when within a certain proximity of a particular point of the vehicle and when the wheel is at a first angular measure;
the light coupled to the wheel of the vehicle.

2. The apparatus of claim 1, wherein the vehicle is a two-wheeled vehicle.

3. The apparatus of claim 1, further comprising an actuator trigger, coupled to the frame of the vehicle, that actuates the actuator when the wheel reaches a particular point in a rotational cycle of the wheel.

4. The apparatus of claim 3 wherein the actuator trigger emits a magnetic field, and the actuator enables the light in response to the magnetic field.

5. The apparatus of claim 1 wherein the actuator is a contact switch, the contact switch transmitting the signal when the contact switch is in contact with the frame of the vehicle.

6. The apparatus of claim 1, wherein the light is activated a single time in response to the signal.

7. The apparatus of claim 1, wherein the light is activated a plurality of times in response to the signal.

8. The apparatus of claim 7, wherein the time for each activation is related to the rotational velocity of the wheel.

9. The apparatus of claim 7, wherein the plurality of times is representative of the rotational velocity of the wheel.

10. The apparatus of claim 1, wherein the light is activated after of a delay of a predetermined amount of time.

11. The apparatus of claim 10, wherein the predetermined amount of time is indicative of the wheel rotating to a second angular measure at a first rotational velocity.

12. The apparatus of claim 11, wherein the first rotational velocity is measured.

13. The apparatus of claim 1, wherein the delay is representative of the wheel rotating a predetermined second angular measure.

14. The apparatus of claim 1, wherein the first direction is substantially parallel to the plane defined by a radius of the wheel.

15. The apparatus of claim 1, wherein first direction is substantially perpendicular to the plane defined by a radius of the wheel and substantially perpendicular to the motion of the vehicle.

16. The apparatus of claim 1, the light comprising two light sources.

17. A method for lighting a vehicle, the vehicle comprising a frame and a wheel, the wheel having a first light disposed on it, the method comprising:
sensing a first angular position of the wheel with a detector;
transmitting a signal indicative of an angular position of the wheel and the associated first light; and
activating, in response to the signal, the first light to shine in a first direction.

18. The method of claim 17, wherein the vehicle is a two-wheeled vehicle.

19. The method of claim 17, the step of sensing comprising:
sensing a positional device coupled to the frame of the vehicle; and
the step of transmitting occurring when detector senses the positional device.

20. The method of claim 19, the step of sensing further comprising:
sensing a magnetic field emitted by the positional device; and
the step of transmitting is initiated in response to the sensing of the magnetic field.

21. The method of claim 17 wherein the step of sensing is performed by a contact switch, the contact switch enabling the transmission of the signal based upon contact with the frame of the vehicle.

22. The method of claim 17, the step of activating comprising:
activating the first light a single time.

23. The method of claim 17, the step of activating comprising:
activating the first light a plurality of times.

24. The method of claim 23, wherein the plurality of times is related to the rotational velocity of the wheel.

25. The method of claim 23, wherein the time for each activation is related to the rotational velocity of the wheel.

26. The method of claim 17, the step of activating comprising:
activating the first light after of a delay of time.

27. The method of claim 17, the step of activating comprising:
determining a delay time indicative of the wheel rotating to a second angular measure; and
activating the first light after the delay time.

28. The method of claim 27, the step of determining comprising:
measuring a rotational velocity of the wheel; and
determining the delay time based upon the rotational velocity.

29. The method of claim 17, wherein the first direction is substantially parallel to the plane defined by a radius of the wheel.

30. The method of claim 17, wherein the first direction is substantially perpendicular to the plane defined by a radius of the wheel and substantially perpendicular to the motion of the vehicle.

31. The method of claim 17, the step of activating comprising:
activating a second light, the first light and the second light emanating light in differing orientations.
